(19) United States
(12) Patent Application Publication
(10) Pub. No.: US 2026/0227951 A1
(43) Pub. Date: Aug. 6, 2026

(54) PHOTO AND IMAGE SCREEN READER FOR THE BLIND

(71) Applicant: Microsoft Technology Licensing, LLC, Redmond, WA (US)

(72) Inventor: Gregory Ward RATAJIK, Seattle, WA (US)

(21) Appl. No.: 19/047,274

(22) Filed: Feb. 6, 2025

(51) Int. Cl. G06F 3/16; G06F 3/0481; G06Q 30/0601; G06V 10/764; G09B 21/00

(52) U.S. Cl. CPC G06F 3/165; G06F 3/0481; G06Q 30/0643; G06V 10/764; G09B 21/001; G06V 2201/10

(57) ABSTRACT

Techniques for assisting visually impaired individuals when working with images are disclosed. A service accesses an image of a scene. The image includes pixels representing an object included in the scene. The service generates a classification for the object pixels and a classification for the scene. The service receives user input directed to the image. The user input includes at least one of: a cursor hovering over one or more of the object pixels, a selection of the one or more object pixels, or a movement of the cursor over the one or more object pixels. In response to the user input, the service triggers playback of an audio output comprising audio details describing the object classification.

### BACKGROUND

There are several levels of help currently available for blind users to understand screen content. One example level involves a screen reader. Screen reader applications provide a narrative description about the tools or controls the user is interacting with. For instance, the application can play back text that is displayed on the control or perhaps near the control. As a specific example, consider a scenario where a user tabs to a button labeled “Submit.” In this scenario, the screen reader will playback a reading of the term “Submit,” thereby enabling the user to decide what action to take.

Another level involves alternative (or simply “alt”) text for images. With this level, web page authors can include alt text that describes the image, where the alt text is stored in metadata for the image. For instance, alt text for a given image might read “A car parked in a driveway.” Notably, this alt text is often very concise and describes the image at a macro level.

Another level involves artificial intelligence (AI) generated summaries. With the rise of AI, new tools can create high-level summaries and descriptions of images. These AI-generated summaries can then be read aloud to the user. Despite these different levels, there is still a substantial need to provide improved methodologies for relaying information to vision impaired people.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system including: one or more processors; and one or more hardware storage devices that store instructions that are executable by the one or more processors to cause the computer system to: access an image of a scene, wherein the image includes pixels representing an object included in the scene; generate, vi a machine learning engine a first classification for the pixels representing the object, wherein first metadata for the object is structured to include the first classification; generate, via the machine learning engine, a second classification for the scene, as represented in the image, wherein second metadata for the image is structured to include the second classification; receive user input directed to the image, the user input including at least one of: a cursor hovering over one or more of the pixels representing the object in the scene, a selection of the one or more pixels representing the object, or a movement of the cursor over the one or more pixels representing the object; and in response to the user input, trigger playback of an audio output including audio details describing the first classification for the object.

In some aspects, the techniques described herein relate to a method including: accessing an image of a scene, wherein the image includes pixels representing an object included in the scene; generating a first classification for the pixels representing the object, wherein first metadata for the object is structured to include the first classification; generating a second classification for the scene, as represented in the image, wherein second metadata for the image is structured to include the second classification; receiving user input directed to the image, the user input including at least one of: a cursor hovering over one or more of the pixels representing the object in the scene, a selection of the one or more pixels representing the object, or a movement of the cursor over the one or more pixels representing the object; and in response to the user input, triggering playback of an audio output including audio details describing the first classification for the object.

In some aspects, the techniques described herein relate to one or more hardware storage devices that store instructions that are executable by one or more processors to cause the one or more processors to: access an image of a scene, wherein the image includes pixels representing an object included in the scene; generate a first classification for the pixels representing the object, wherein first metadata for the object is structured to include the first classification; generate a second classification for the scene, as represented in the image, wherein second metadata for the image is structured to include the second classification; receive user input directed to the image, the user input including at least one of: a cursor hovering over one or more of the pixels representing the object in the scene, a selection of the one or more pixels representing the object, or a movement of the cursor over the one or more pixels representing the object; and in response to the user input, trigger playback of an audio output including audio details describing the first classification for the object.

In some aspects, the techniques described herein relate to a computer system including: one or more processors; and one or more hardware storage devices that store instructions that are executable by the one or more processors to cause the computer system to: access an image of a scene, wherein the image includes pixels representing an object included in the scene; generate, via a machine learning engine, a first classification for the pixels representing the object, wherein first metadata for the object is structured to include the first classification; generate, via the machine learning engine, a second classification for the scene, as represented in the image, wherein second metadata for the image is structured to include the second classification; receive user input directed to the image, the user input including at least one of: a cursor-based selection of the one or more pixels representing the object or an audio-based user command including audio details regarding selection of the one or more pixels representing the object; and in response to the user input, generate a cropped image that includes the one or more pixels representing the object.

In some aspects, the techniques described herein relate to a computer system including: one or more processors; and one or more hardware storage devices that store instructions that are executable by the one or more processors to cause the computer system to: access an image of a scene, wherein the image includes pixels representing an object included in the scene; generate, via a machine learning engine, a first classification for the pixels representing the object, wherein first metadata for the object is structured to include the first classification; generate, via the machine learning engine, a second classification for the scene, as represented in the image, wherein second metadata for the image is structured to include the second classification; receive user input directed to the image, the user input including a definition for a boundary that is to be imposed on the image, the boundary being usable to indicate whether an action is occurring in the scene; and in response to the user input, modify the image to include the boundary.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture designed to assist visually impaired individuals in working with images.

FIG. 2 illustrates an example of an image of a scene.

FIG. 3 illustrates an object that has been segmented.

FIG. 4 illustrates additional objects included in a scene.

FIGS. 5, 6, 7, 8, 9, 10, and 11 illustrate various examples scenarios in which the disclosed service assists a user in interacting with an image.

FIGS. 12A, 12B, and 12C illustrate scenarios involving the definition of a rule or boundary in an image.

FIGS. 13A and 13B illustrate flowcharts of an example method for improving how a user interacts with an image.

FIG. 14 illustrates an example computer system that can be configured to perform any of the disclosed operations.

### DETAILED DESCRIPTION

As mentioned earlier, there is still a substantial need to provide improved methodologies for relaying information to vision impaired people. The disclosed embodiments provide techniques that enable visually impaired users to obtain real-time narration of image content. In some scenarios, these techniques involve the user moving a pointer device (e.g., a mouse cursor) over an image (or any type of displayed content) displayed on an electronic device. Unlike traditional screen readers that narrate only control text and other proximate text and unlike alt text or AI-generated summaries that provide high-level overviews, the disclosed embodiments allow users to interactively navigate images, thereby receiving detailed auditory descriptions based on the precise location of the pointer.

The disclosed embodiments especially address a gap in existing tools by providing a real-time, interactive, and detailed specific narration of specific image content. The disclosed embodiments allow a user to move his/her cursor over a photo, and the embodiments will dynamically respond by narrating the specific content located underneath the cursor.

For example, in a photo of a grocery store, as the user moves the mouse over different areas of the image, the embodiments might announce “A white tiled floor situated underneath two aisles,” “[Brand] laundry detergent located on the third shelf of an aisle,” “A medium sized hair spray located next to a pink comb,” “A rubber spatula located next to a rolling pin,” and so on.

Notice the level of details included with each object description. The embodiments do not just simply perform object segmentation and recognition; rather, the embodiments obtain a deeper understanding of the object itself (and its positional information relative to other objects in the image) and provide enhanced details in the audio playback response. Such processes enable users to gain a detailed understanding of the photo's contents and the spatial relationships between items.

By implementing the disclosed principles, the embodiments unlock several classes of improved use case scenarios. For instance, the embodiments enable a better, deeper understanding of an image. By allowing users to gain a pixel-level knowledge of what they are navigating over in the image, users can gain an exact understanding of the contents, locations, and relationships of items within the photo.

The embodiments also facilitate guided editing of the image. For instance, by adding context about the pointer's position relative to items in the image, users can now perform basic editing tasks. For example, if the item is a car, the playback audio can describe the pointer's location in relation to the car (e.g., “middle top,” “left top,” “left bottom,” “right bottom,” “right top”). In some scenarios, instead of using the cursor, the user can narrate the portion of the image that is to be cropped (e.g., by saying a phrase such as “create a cropped image of the car”). Based on the user's verbal instruction, the embodiments can implement the editing.

As users navigate over a desired feature or object, they can also click and drag to the opposite side of the object to perform tasks such as cropping, copying, filling, or outlining. The user will know when he/she has reached the opposite corner based on the playback provided by the embodiments.

The embodiments also facilitate machine learning (ML) camera parameters. For example, when using ML on video streams, users often desire to define bounding boxes or boundary lines that the model uses to understand activity within a photo. For example, it is possible to understand a store's capacity by detecting when a person crosses a threshold (e.g., door or entrance). A user is presented with a frame from the video stream and can draw a boundary line (or “rule” or “condition”) relative to that frame. The boundary will persist for subsequent frames of the video.

This boundary can be used to determine the number of individuals who cross the boundary. A visually impaired person, enabled with pixel-level narration, can now implement these operations. For example, similar to the editing tasks, the embodiments can describe where the user's cursor is in the photo (e.g., “floor,” “bottom left of door,” “bottom right of door,” “wall,” etc.). When the user is in the desired location, he/she can click and drag to create a line (e.g., at “bottom left of door,” the user clicks and holds, and when the user moves to “bottom right of door,” the user releases the hold, thereby completing the task).

Current narrators for images and photos are very limited. For instance, current narrators will either read alt text (which the developer of the web page must enter in, likely with wildly varying quality) or will rely on the use of machine learning to try to describe the image. Consider an image of a grocery store. A traditional narration might end up being something like “A grocery store with products on shelfs.”

In contrast to those high level descriptions, the disclosed embodiments are able to perform object segmentation on the image to identify each and every discrete object represented in the image. The embodiments can create a bounding box or contour around the object and can include label data or metadata for the identified objects. This metadata can include specific details about the object, such as, but not limited to, size, color, brand, quantity, spatial relationship data, and so on, without limit.

Subsequently, the user can move a cursor (e.g., perhaps a mouse cursor or even perhaps the user's own finger on a touchscreen device) over the image. This movement can trigger the embodiments to play back the description for whatever object is currently in focus (e.g., the object over which the cursor is located). The embodiments can thus provide a detailed list of what is in the image, along with spatial information on where the current object item is located.

The embodiments also enable search features, which can be triggered based on a request submitted by the user (e.g., perhaps a spoke request). For instance, the user might speak “Find the car.” In response, the cursor can be navigated over top of the car, and the embodiments may then provide an audio output stating how the car is now in the center of focus for the cursor. By performing the disclosed operations, the embodiments significantly improve how images are processed and how they are interacted with by visually impaired individuals.

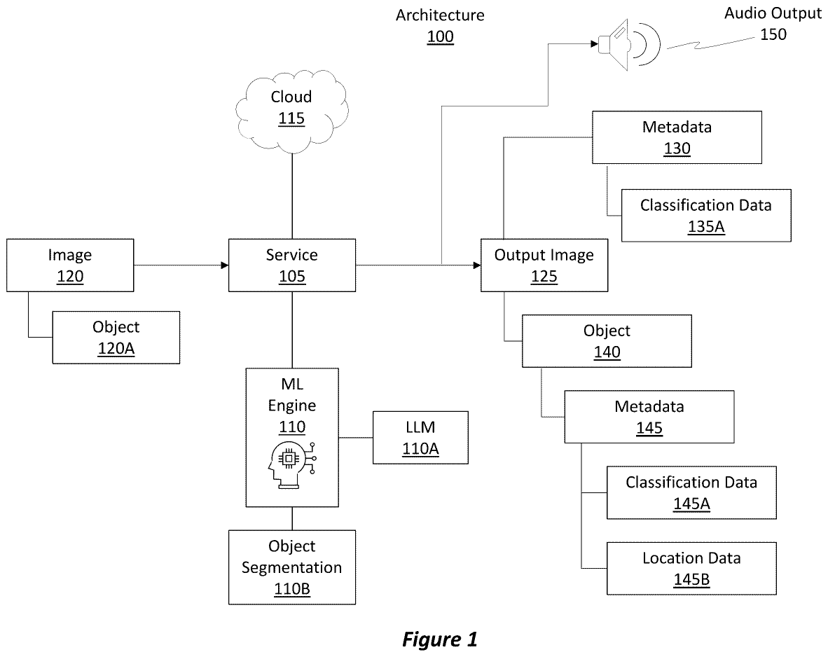

Having just described some of the high level benefits, advantages, and practical applications achieved by the disclosed embodiments, attention will now be directed to FIG. 1, which illustrates an example computing architecture 100 that can be used to achieve those benefits. Architecture 100 includes a service 105, which can be implemented on any type of computing system.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 110. The ML engine 110 enables the service to operate even when faced with a randomization factor. ML engine 110 may include any type of large language model (LLM) 110A. ML engine 110 (including the LLM 110A) can perform any type of object segmentation 110B on images.

As used herein, reference to any type of machine learning, LLM, or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 115 environment. In some implementations, service 105 is a local service operating on a local device. In some implementations, service 105 is a hybrid service that includes a cloud component operating in the cloud 115 and a local component operating on a local device. These two components can communicate with one another.

Service 105 is tasked with accessing an image 120 of a scene. The image 120 includes pixels representing an object 120A included in the scene. The image 120 may be a single image or may be included in a stream of multiple images forming a video.

Service 105 then generates a new output image or modifies the existing image 120 to include additional content. Regardless of whether a new output image is generated or the existing image 120 is modified, service 105 produces or generates the output image 125. This output image 125 includes the same visual details as the image 120. Thus, the object 120A is still represented in the output image 125, as generally shown by object 140. That is, object 140 corresponds to object 120A.

Service 105 uses the LLM 110A to generate metadata 145 for the object 140 in the output image 125. This metadata 145 includes classification data 145A for the pixels representing the object 140, where the classification data 145A is generated by the LLM 110A.

In this regard, the metadata 145 for the object 140 is structured to include the classification data 145A. Service 105 also uses the LLM 110A to generate location data 145B for the object 140, and this location data 145B is included in the metadata 145. The location data 145B may include any type of location information or spatial relativity data.

One example of such information includes the pixel coordinates of the object 140 within the confines of the output image 125. To illustrate, suppose the image is a standard resolution 8 inch×10 inch image having 1440×1800 pixels. The embodiments can identify the object 140 within the output image 125 and can generate a bounding box (or any type of boundary or contour) around the object 140. The pixel coordinates of this bounding box can then be used as the location data 145B.

Additionally, or alternatively, the location data 145B may include granular spatial information for the object 140 relative to other objects represented in the output image 125. As an example, suppose the object 140 is a cereal box that is shown as being physically near a bag of cereal. Service 105 is able to identify this spatial relationship (e.g., “the cereal box is near the bag of cereal”) and can include that information in the location data 145B.

In some scenarios, service 105 can even estimate the distance that exists between the two objects, even though the image is a two-dimensional image. For instance, service 105 may determine that the cereal box is approximately two feet away from the bag of cereal.

Additionally, or alternatively, the location data 145B may include higher level spatial information for the object 140. As an example, suppose the object 140 is located on the third shelf of aisle #3 in a grocery store. Service 105 can identify aisle #3 based on signage in the store. Service 105 can also identify the shelves in the aisle. Service 105 can then determine that the object 140 is located on the third shelf from the bottom. Thus, higher level spatial information can be included in the location data 145B.

Service 105 also uses the LLM 110A to generate metadata 130 for the entire output image 125, such as the scene that is represented by the output image 125. In this regard, service 105 generates classification data 135A for the scene, as that scene is represented in the output image 125. Thus, the metadata 130 for the output image 125 is structured to include the classification data 135A. The classification data 135A may include a high level description of the scene.

In some embodiments, the amount of detail provided in the high level description may vary depending on the movement of the user's cursor or fingertip (e.g., in the case of a touchscreen). In one example, consider a scenario where the user brings the image to the forefront of the display, but perhaps the user's cursor is not hovering over the image. In this scenario, service 105 may provide an initial high level description of the image. If the image remains at the forefront and if the user does not move his/her cursor, service 105 may continue to provide additional details describing the image, and service 105 may even start to provide specific, granular details. Thus, the longer the image remains at the forefront and the longer the user's cursor is not displayed over top of a specific item, service 105 may be tasked with providing a progressively more detailed description of the item.

As an example, suppose the image is of a grocery store. Given the above conditions, service 105 may initially provide the following description: “the image shows a grocery store having multiple aisles, each with multiple shelves.” As time progresses, service 105 may begin to describe the objects that are placed on the shelves, such as by providing product details, positional information, and so on. As time further progresses, service 105 may begin to provide even more granular details, such as color, size, position relative to other objects, brand name, quantity, etc. Thus, service 105 may be tasked with progressively providing more details in response to the image remaining in the forefront and in response to the user's cursor not hovering over any specific object. In the event the user's cursor does hover over a specific object, service 105 will shift the objective of generally describing the scene as a whole to specifically describing the object now at the center of focus. Thus, different information can be provided based on the activity (or lack thereof) of the user.

To continue with the above grocery store example, the classification data 135A for the grocery store might include a description such as the following: “This image shows three different aisles of a grocery store, including aisles #1, #2, and #3.” “Aisle #3 appears to have breakfast items, such as cereal.” “Aisle #2 appears to have bread items.” “Aisle #1 appears to have baking supplies.” “The three aisles are also positioned near a small display shelf.” Further information can be provided. Thus, the classification data 135A includes granular details for the scene as a whole, and those granular details can be narrated or played back via service 105.

In FIG. 1, service 105 is also tasked with receiving user input directed to the output image 125. The user input includes at least one of: a cursor hovering over one or more of the pixels representing the object 140 in the scene, a selection of the one or more pixels representing the object 140, or a movement of the cursor over the one or more pixels representing the object 140. In some scenarios, the user input may further include a cursor-based selection of the one or more pixels representing the object or an audio-based user command comprising audio details regarding selection or identification of the object's pixels.

In response to the user input, service 105 then triggers play back of an audio output 150 comprising audio details describing the classification data 145A for the object 140. Other parts of the metadata 145, such as the location data 145B, may also be included in the audio output 150. By performing these operations, service 105 is able to enhance how a visually impaired individual interacts with an image. As the user's cursor moves over different objects in the output image 125, a narrative detailed description of those objects will also be provided. Those details are generated by the LLM 110A.

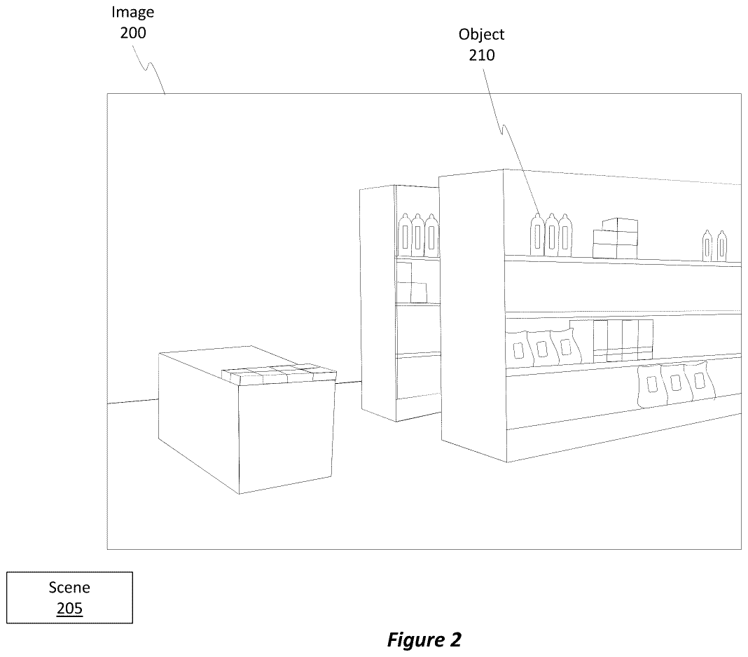

Having just described some of service 105's operations at a high level, specific examples will now be recited using the subject matter illustrated in FIGS. 2 through 12C. A person skilled in the art will recognize how these illustrations and scenarios are being provided for example purposes and how the disclosed concepts and principles can be applied more generally or in a broader manner.

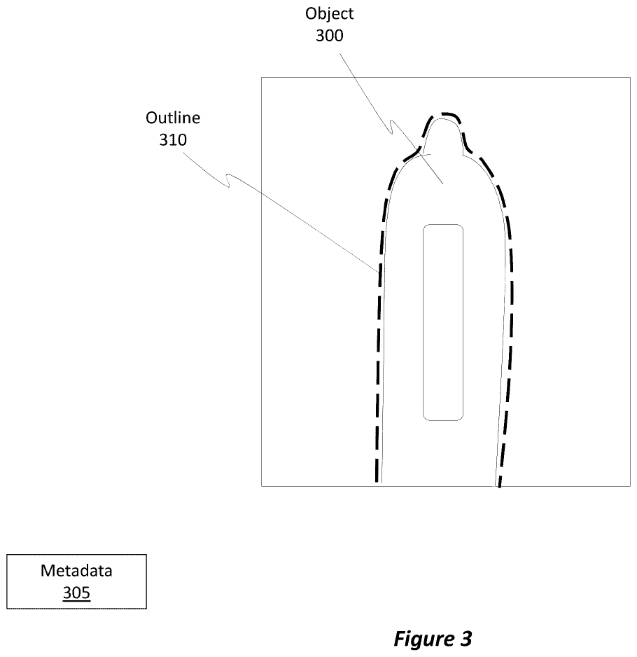

FIG. 2 shows an example image 200 of a scene 205. Image 200 corresponds to the input image 120 of FIG. 1. Image 200 also includes pixels that represent an object 210 included in the scene 205. In accordance with the disclosed principles, service 105 of FIG. 1 is able to perform object segmentation 110B on image 200 (e.g., perhaps using the LLM 110A) to identify not only object 210 but also the other objects that are represented in image 200. FIG. 3 is illustrative.

FIG. 3 shows the object 300, which corresponds to object 210 of FIG. 2. Service 105 is able to generate metadata 305 for object 300. Metadata 305 may include any detail about the object 300, such as its color properties, location properties, size, brand, configuration, shape, orientation (e.g., the view of the object may be a side angled view or a front facing view or a top angled view), and so on, without limit. Service 105 may be further tasked with generating an outline 310 around the object 300 as a part of the segmentation process. Pixels bounded by the outline 310 are identified as pixels representing the object 300. For instance, in FIG. 3, object 300 corresponds to a hairspray can as viewed from a front perspective. The pixels bounded by outline 310 are the pixels representing the hairspray can. The center strip shown in FIG. 3 corresponds to the label for the hairspray can. If the label is sufficiently recognizable, service 105 is able to discern the label details and include those details in the metadata 305.

The outline 310 shown in FIG. 3 is shown as being closely or exactly aligned with the border of object 300. In other scenarios, the outline 310 may include a simple shape, such as a square, rectangle, oval, triangle, quadrilateral, pentagon, hexagon, heptagon, octagon, or some other shape that is not specifically aligned to match the border of the object 300.

Thus, in some scenarios, outline 310 is structured so as to encompass pixels that correspond only to the object 300. In some scenarios, outline 310 is structured in a manner so that a majority, or at least a threshold number, of pixels bounded by the outline 310 correspond to the object 300. In other scenarios, outline 310 is structured as a simple shape (e.g., a rectangle) and no threshold is defined with regard to the number of pixels that correspond to the object 300 or that do not correspond to the object 300. For instance, if a rectangle were drawn around object 300 in FIG. 3, many pixels (e.g., such as those around the cap) would not be pixels corresponding to the hairspray can. In that scenario, the rectangle would thus include non-object specific pixels. Accordingly, different parameters can be relied on when determining how to structure the outline 310.

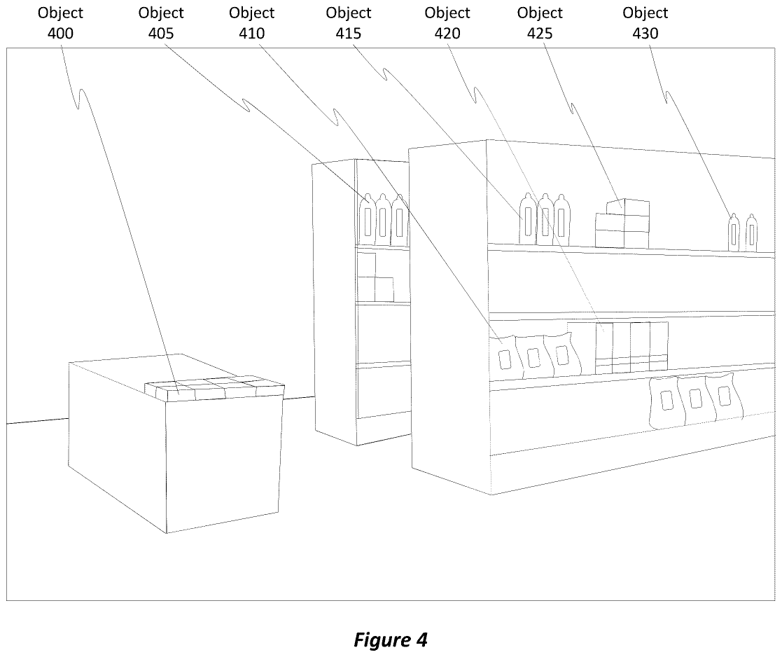

FIG. 4 shows an example scenario where other objects in the scene are identified via the LLM 110A. For instance, objects 400, 405, 410, 415, 420, 425, and 430 are identified. Although not shown in FIG. 4, each of these objects may have their own corresponding outline generated.

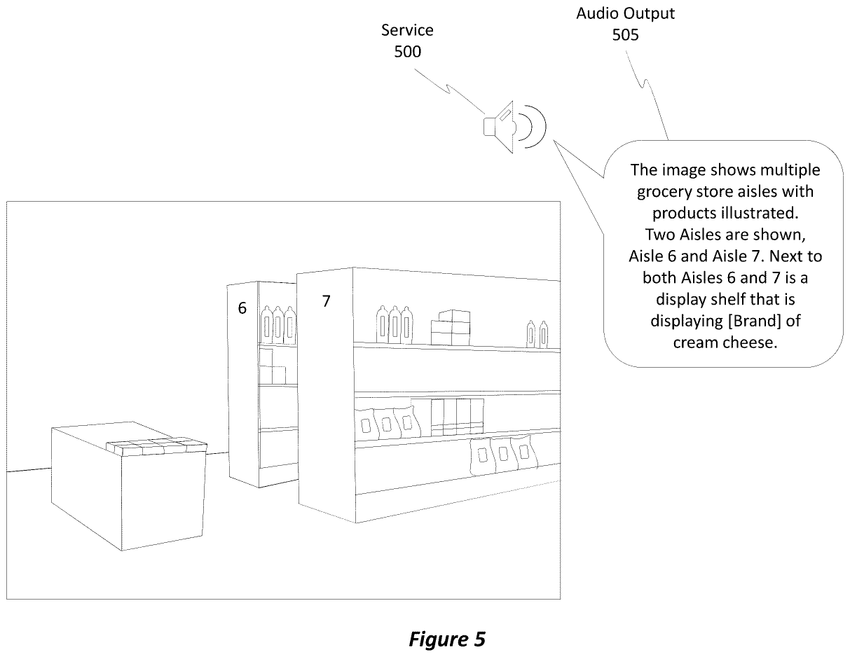

Having identified the various different objects in the scene and having generated granular details about each of those objects, service 105 is now in a state where it can play back information to a user and/or provide editing or rule formation scenarios. FIG. 5 is illustrative.

FIG. 5 shows the service 500 having the ability to play audio over a speaker. The services illustrated in the various figures of this disclosure correspond to service 105 of FIG. 1.

In this scenario, the user is not currently hovering a cursor over any specific object in the scene. Instead, the image as a whole is generally the focus. As such, service 500 is tasked with describing the context of the scene as a whole. Initially, that description may be a high level description, but as time progresses, more and more details may be provided and optionally generated if not previously generated.

In this scenario, service 500 is providing the audio output 505 which includes the following language played over the speaker: “The image shows multiple grocery store aisles with products illustrated.” “Two aisles are shown, Aisle 6 and Aisle 7.” “Next to both Aisles 6 and 7 is a display shelf that is displaying [Brand] of cream cheese.” If the image continues to remain at the forefront of the display, service 500 may start to describe specific features of the objects in the scene, such as perhaps the spacing between the shelves, the color of the floor and the shelves, the number of objects on the shelves, the types of objects on the shelves, the positional relationships between the different objects, and so on. More details may be narrated as time progresses, where those details are dynamically generated by the LLM 110A.

Notably, service 500 is able to identify the specific brand of cream cheese because that brand information is discernable from the image itself. Thus, service 500 can obtain specific object details about items in the image, where those specific details can be discerned from packaging labels, object features, or other characteristics. In some scenarios, service 500 can also query the Internet in an attempt to obtain further information about the objects or even to the same or a different LLM. For instance, if the size of the product is not discernable from text in the image, service 500 can query the Internet in an attempt to determine what size the object is based on an image matching operation. Service 500 can also obtain additional details, such as perhaps nutrition facts or manufacturing origin information. If the objects are not products but rather are other object types, specific details for those other objects can be obtained as well in a similar manner.

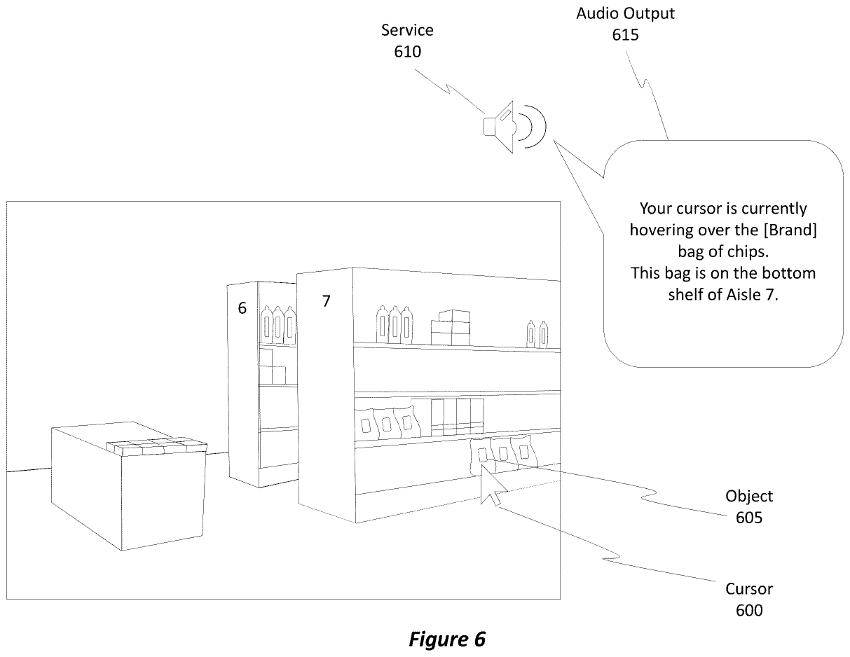

FIG. 6 shows a scenario where the user's cursor 600 is now displayed over top of an object 605. Such an action can occur (i) as a result of the cursor 600 hovering over the object 605 for at least a threshold amount of time (so as to qualify as “hovering”), (ii) as a result a selection of the object 605, or (iii) as a result of a continued movement of the cursor 600 over the object 605. The action may also occur in response to a user verbal instruction, such as “navigate my cursor over the top left corner of the bag of chips on Aisle 7.”

In response to that user input, service 610 plays back the audio output 615. In this scenario, the audio output 615 includes the following spoken language: “Your cursor is currently hovering over the [Brand] bag of chips.” “This bag is on the bottom shelf of Aisle 7.”

Notice again, specific details for object 605 are provided. For instance, service 610 is able to discern the packaging type (e.g., “bag” as compared to a “box”) for the object 605. Service 610 is also able to determine the type of the object 605 (e.g., “chips”). Service 610 also recognizes the location or position of the object 605 relative to other objects (e.g., relative to Aisle 7 and the position on Aisle 7). Service 610 also differentiates between the different shelves and can use less formal language or more colloquial language, such as “bottom” shelf as opposed to “first shelf from the floor.”

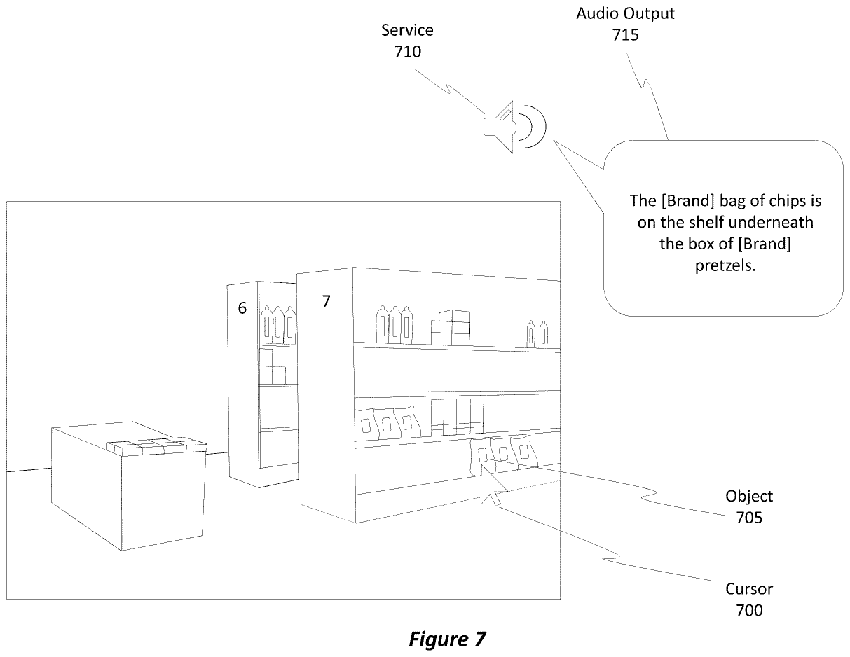

FIG. 7 shows the cursor 700 over the object 705. Service 710 plays back the audio output 715. In this scenario, the audio output 715 includes specific spatial information of the object 705 relative to another object that is proximate. For instance, audio output 715 includes the following language: “The [Brand] bag of chips is on the shelf underneath the box of [Brand] pretzels.” Thus, specific details about the other object (e.g., brand, box, and the type—pretzels) are provided as well as the spatial details (e.g., on the shelf underneath).

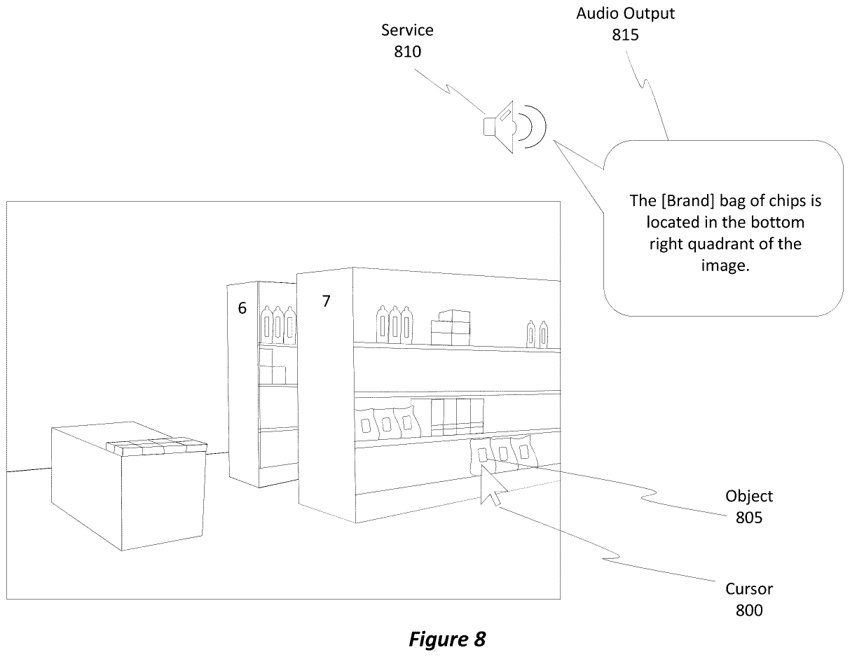

FIG. 8 shows the cursor 800 over object 805. Service 810 plays back the audio output 815. In this scenario, the audio output 815 includes spatial information of the object 805 relative to the bounds of the image. For instance, audio output 815 includes the following language: “The [Brand] of chips is located in the bottom right quadrant of the image.” Thus, location details of an object relative to the boundary of the image can be provided.

In some scenarios, the pixel coordinate data can be provided. In some scenarios, instead of giving an absolute pixel coordinate value relative to an origin (e.g., relative pixel origin 0×0), service 810 can inform the user that the cursor 800 is “X” number of pixels from the closest left or right side and “Y” number of pixels from the closest top or bottom side. Additionally, or alternatively, service 810 can inform the user that the cursor is 0.5 inches from the righthand border of the image and 2.74 inches from the bottom border.

As another example, in FIG. 8, service 810 might play back the following: “your cursor is 100 pixels from the right edge of the image and 300 pixels from the bottom edge of the image.” In other scenarios, service 810 might playback the following: “your cursor is at pixel coordinates [X] and [Y].”

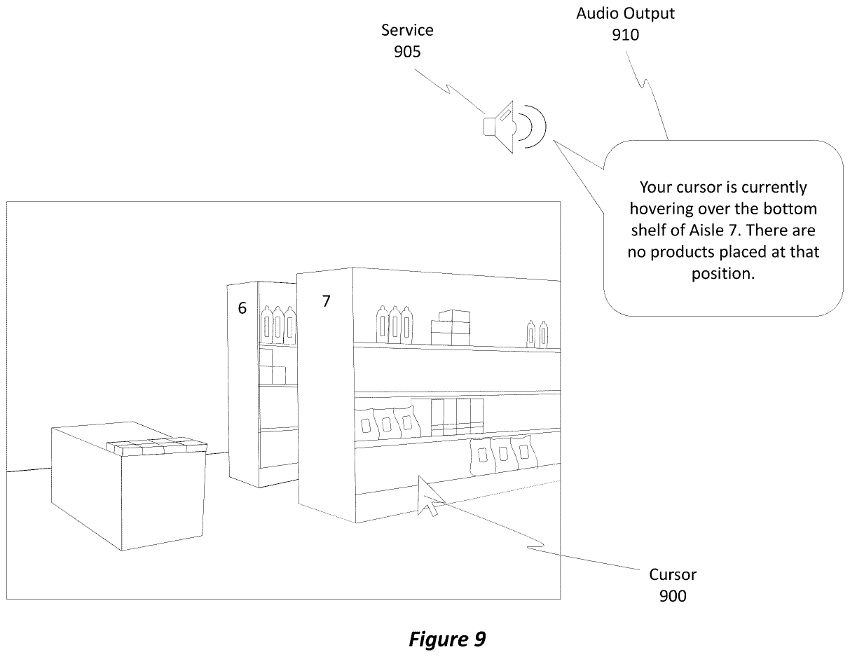

FIG. 9 shows a scenario where the cursor 900 is positioned over a shelf but no products are at the cursor's position; instead, only the shelf is visible at that position. In this scenario, service 905 generates the audio output 910, which includes the following language: “Your cursor is currently hovering over the bottom shelf of Aisle 7.” “There are no products placed at that position.” Thus, service 905 has a positional awareness as to the location of the cursor relative to at least some objects in the scene (e.g., the shelf of Aisle 7), and service 905 can recognize that in some scenarios other objects would normally be located there but in this scenario no objects are at that location. In some embodiments, if the cursor is allowed to remain at that position, service 905 will begin to describe the objects that are located near the cursor and perhaps will provide details as to how far away those objects are. As one example, service 905 may provide the following details: “located on the same shelf as where your cursor is pointing is a bag of chips.” “The chips are about 1 foot away from where your cursor is pointing in terms of scale relative to the scene.” “The chips are about 0.5 inches away from where your cursor is pointing in terms of scale relative to the image dimensions.”

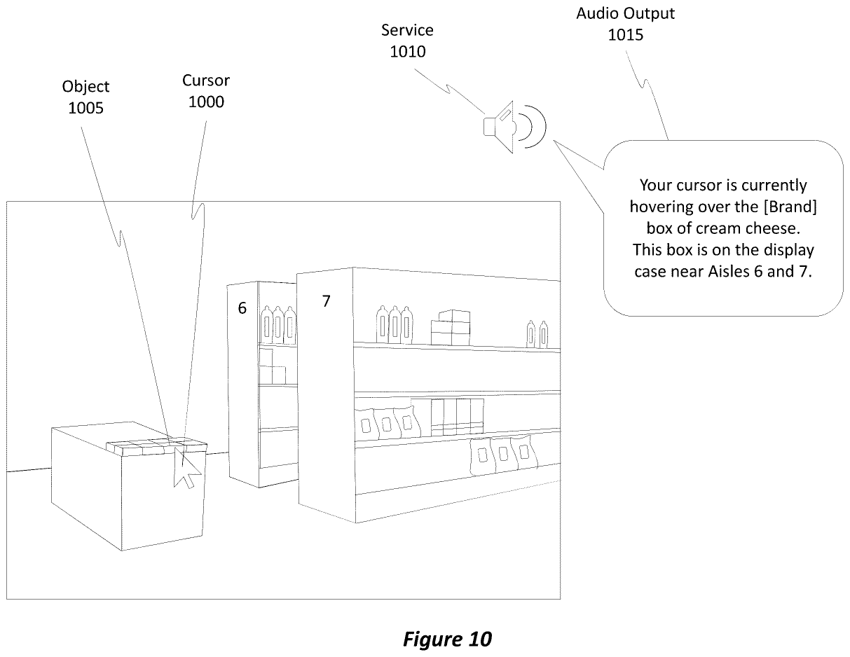

FIG. 10 shows a scenario where the cursor 1000 is positioned over object 1005. Service 1010 then plays back the following audio output 1015:“Your cursor is currently hovering over the [Brand] box of cream cheese.” “This box is on the display case near Aisles 6 and 7.” Notice, in this description, specific object details are provided, where those details are discerned from content included in the image (e.g., perhaps the Brand name is visible in the image). This description further includes spatial data between the different objects.

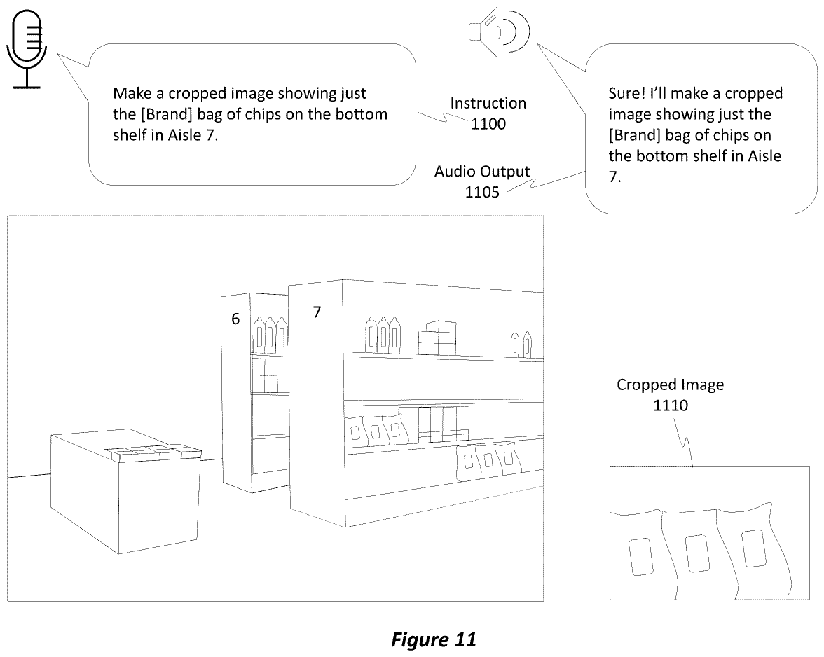

FIG. 11 demonstrates some editing operations that can now be performed by visually impaired individuals. In the scenario shown in FIG. 11, a user provides an instruction 1100. In this scenario, the instruction 1100 includes the following details: “Make a cropped image showing just the [Brand] bag of chips on the bottom shelf in Aisle 7.” The service then provides a response in the form of the following audio output 1105:“Sure!” “I'll make a cropped image showing just the [Brand] bag of chips on the bottom shelf in Aisle 7.” The service then generates the cropped image 1110 showing the designed content.

Optionally, the user can specify parameters for the cropping or editing operation. For instance, the user can specify how the cropped image can be that of a simple rectangle. Alternatively, the user can specify how the cropped image should be a contour that closely or exactly matches the boundary of the identified object. Other shapes can be specified as well. The user can also specify additional editing operations to be performed on the cropped image, such as color modification, transparency, stylistic changes, and so on.

Because the service previously segmented the object and provided tagged identifying information for the recognized objects, the service is able to recognize the objects referenced in the user's instruction 1100. The service is also able to determine which specific editing action the user desires. Thus, even though the user is visually impaired, the actions desired by the user can be implemented by the disclosed service.

The cropping action shown in FIG. 11 is but one example of an editing operation that can be performed by the disclosed service. Other editing can also be performed. For instance, text can be added to the image, transparency operations can be performed, color changes can be made, stylistic changes can be performed, image corrections (e.g., red eye correction) can be performed, background removal can be performed, artistic effects can be implemented, compression operations can be performed, border styles can be implemented, transparency operations can be performed, merging between different images can be performed, and so on without limit.

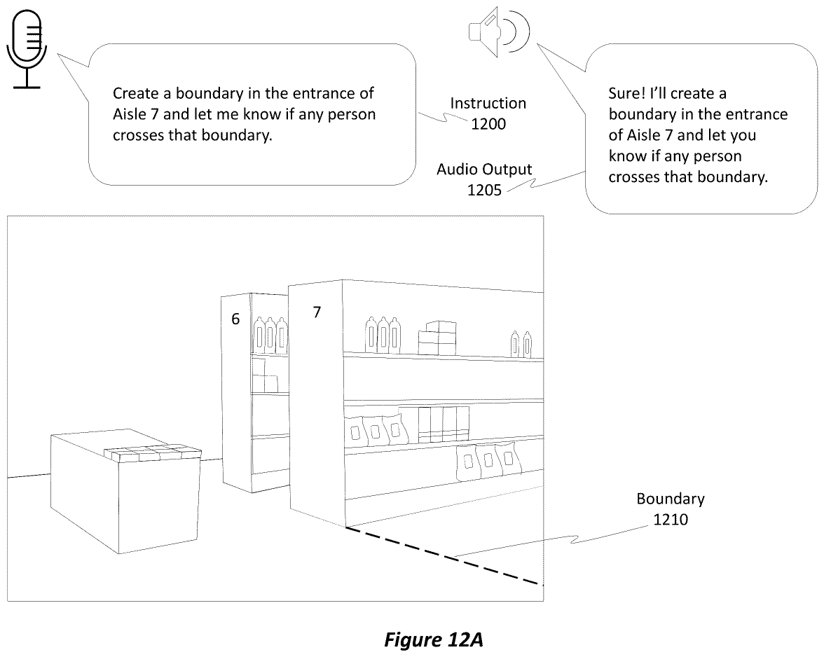

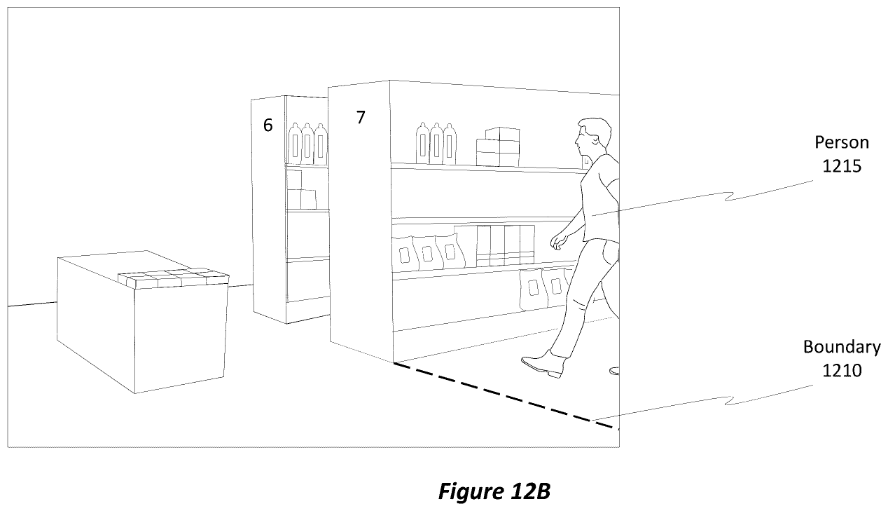

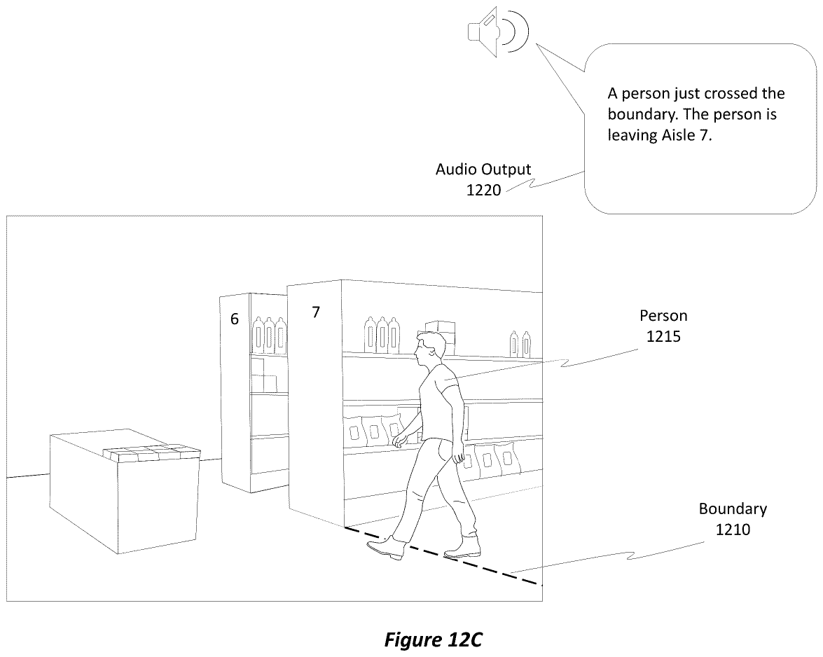

FIG. 12A shows a scenario where different rules or conditions can be imposed on an image, which may be included in a stream of multiple images in the form of a video. This rule or condition can be established with respect to one image and then imposed across the stream of images.

To illustrate, FIG. 12A shows an instruction 1200 from the user, where the instruction 1200 includes the following language: “Create a boundary in the entrance of Aisle 7 and let me know if any person crosses that boundary.” In response, the service provides the audio output 1205, which includes the following language: “Sure!” “I'll create a boundary in the entrance of Aisle 7 and let you know if any person crosses that boundary.” Subsequently, the boundary 1210 is generated. The LLM 110A is able to identify the desired location for the boundary, and the service can then place the boundary at the desired location.

This boundary 1210 is a two dimensional (2D) rule that is imposed against a three dimensional (3D) scene. The boundary 1210 is defined relative to the image shown in FIG. 12A, but it will also be imposed against images included in a stream of images forming a video. For instance, FIG. 12B shows a subsequent image against which the boundary 1210 is still imposed. This image and the one shown in FIG. 12A were generated by the same camera, which is typically retained at the same position. In the scenario shown in FIG. 12B, a person 1215 is shown as entering the field of view of the image. Currently, however, the person has not crossed the boundary 1210.

FIG. 12C shows a subsequent image generated by the same camera that generated the earlier images. Again, the boundary 1210 is imposed on this image. In this scenario, the person 1215 has now crossed the boundary 1210. The act of the person 1215 crossing the boundary 1210 corresponds to the instruction 1200 in FIG. 12A. That is, if a person crosses the boundary 1210, then the user wants to be notified. In FIG. 12C, the service responds by providing the following audio output 1220:“A person just crossed the boundary.” “The person is leaving Aisle 7.”

In some scenarios, the user performs the drawing of the line or condition. For instance, if the user wanted to visualize or edit the frame, the line would be shown on the latest frame from the camera. The system can store the coordinates of the line (e.g., [x, y] and [x1, y2]) of the line. The system (e.g., the ML engine) can then use those dimensions to perform the processing. The stored coordinate information can be used to draw back on the image for review or editing.

Historically, vision impaired individuals were not able to easily edit or augment images in the manner just described with regard to FIGS. 12A through 12C. By implementing the disclosed principles, enhanced viewing, editing, and supplementing to images can now be performed for any individual, including vision impaired individuals. Furthermore, these viewing activities, editing activities, and supplementing activities can be triggered via verbal commands or through other commands (e.g., mouse operations).

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

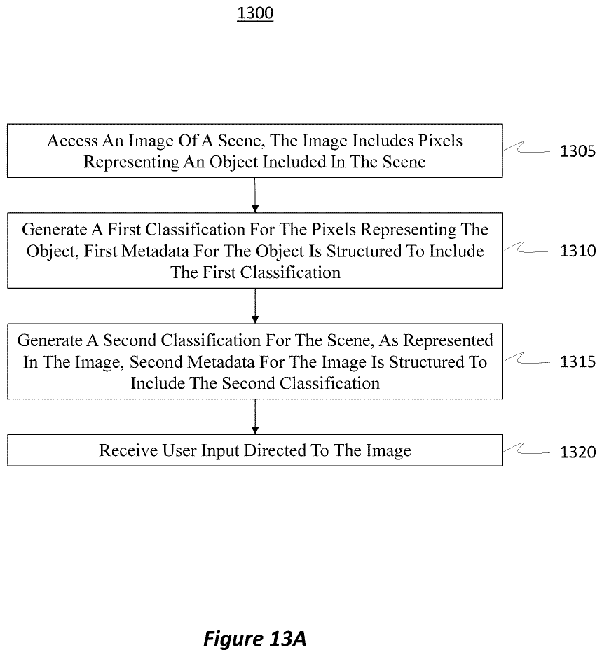

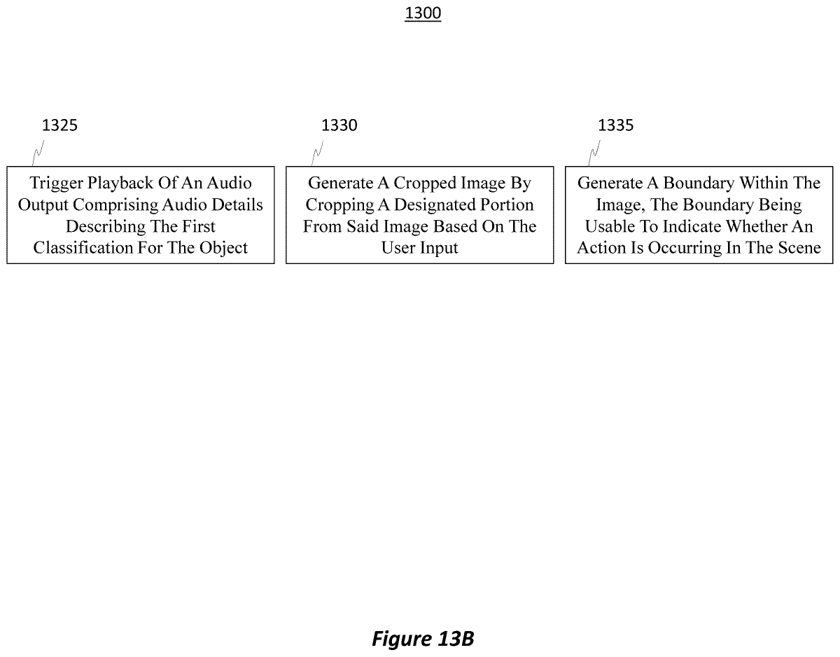

Attention will now be directed to FIGS. 13A and 13B, which illustrate various flowcharts of an example method 1300 for enhancing an image and for facilitating the performance of various activities using that enhanced image. Method 1300 can be implemented within the architecture 100 of FIG. 1. Also, method 1300 can be performed by service 105.

Method 1300 includes an act (act 1305) of accessing an image (e.g., image 200 of FIG. 2) of a scene (e.g., scene 205). The image includes pixels representing an object (e.g., object 210) included in the scene.

Act 1310 includes generating, via a machine learning engine (e.g., perhaps a large language model (LLM)), a first classification (e.g., classification data 145A in FIG. 1) for the pixels representing the object. First metadata (e.g., metadata 145) for the object is structured to include the first classification. Often, the process of generating the first classification is performed via object segmentation of the image.

Optionally, the first classification includes a determined type (e.g., labeling information) for the object (e.g., an animal type, a human type, a product type, etc.). In some scenarios, the first metadata for the object further includes location data for the object. This location data may include image pixel coordinates for the pixels relative to the image. This location data may additionally or alternatively include proximity information of the object represented by the image relative to another object that is also represented in the image.

Act 1315 includes generating, via the machine learning engine, a second classification (e.g., classification data 135A) for the scene, as represented in the image. Second metadata (e.g., metadata 130) for the image is structured to include the second classification. Optionally, the second metadata for the image includes descriptions of multiple different groups of objects, where one group includes the original object. For instance, the groups can be organized based on similar characteristics of the object (e.g., perhaps multiple of the same product are grouped together) or perhaps based on physical locations of objects (e.g., objects are placed on the same shelf). The groupings can be formed based on any type of grouping parameter.

As another option, the second classification for the scene includes a description of multiple different objects that are included in the image and that are included in the scene. These multiple different objects include the original object, and the second classification includes the second classification including relative proximity information for the multiple different objects.

Act 1320 includes receiving user input directed to the image. The user input includes at least one of: a cursor hovering over one or more of the pixels representing the object in the scene, a selection of the one or more pixels representing the object, or a movement of the cursor over the one or more pixels representing the object. In some scenarios, the user input includes at least one of: a cursor-based selection of the one or more pixels representing the object or an audio-based user command comprising audio details regarding selection or identification of the one or more pixels representing the object.

In response to the user input, act 1325 shown in FIG. 13B includes triggering playback of an audio output (e.g., audio output 615 shown in FIG. 6) comprising audio details describing the first classification for the object. Optionally, the audio output may be generated by a machine learning engine (e.g., perhaps a large language model (LLM)). That is, an LLM may generate the first classification, the second classification, and the audio output.

Additionally or as an alternative to act 1325, method 1300 may include an act 1330 of (e.g., in response to the user input) generating a cropped image that includes the one or more pixels representing the object. Additionally or as an alternative to acts 1325 and/or 1330, method 1300 may include an act 1335 of generating a boundary. This boundary is a 2D boundary that is evaluated relative to a 3D scene. For instance, the embodiments may receive user input directed to the image, where the user input includes a definition for a boundary that is to be imposed on the image. The boundary is usable to indicate whether an action is occurring in the scene. In response to the user input, the embodiments can modify the image to include the boundary. Conditions or rules can be associated with the boundary. For instance, the conditions may specify that if the boundary is crossed by a specific type of entity (e.g., a human), then an audio alert is to be triggered. Of course, other conditions or rules can be imposed as well.

In some scenarios, the audio details further include location information for the object. Optionally, the location information includes a proximity of the object relative to a second object that is also represented in the image and that is included in the scene.

In some implementations, the object is a product, and the first classification includes product details for the product. Here, at least some of the product details are identified from recognizable package details for the object, as identified from within the image.

In some scenarios, the image includes second pixels representing a second object in the scene. The disclosed service can further generate a third classification for the second pixels representing the second object in the scene. Third metadata for the second object is structured to include the third classification. The audio details mentioned earlier may further include location information describing a proximity of the object relative to the second object in the scene.

Optionally, method 1300 includes an act of receiving second user input. This second user input includes the cursor hovering over one or more of the second pixels representing the second object. In response to the second user input, there is an act of triggering playback of a second audio output comprising second audio details describing the second object. The second audio details includes information describing the proximity of the object relative to the second object in the scene.

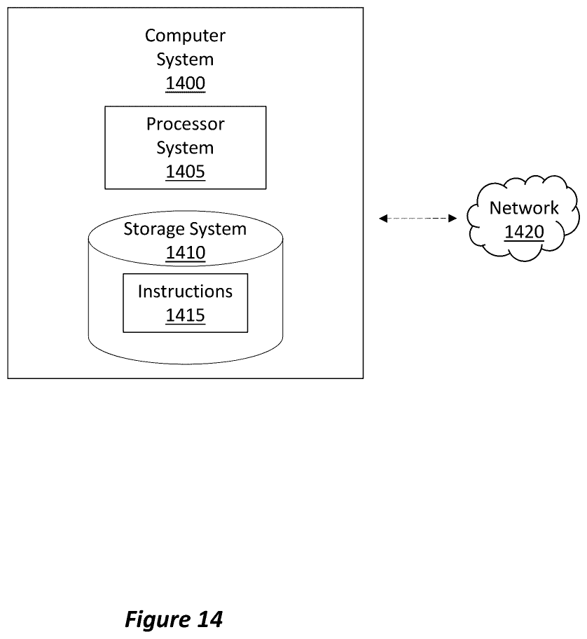

Attention will now be directed to FIG. 14 which illustrates an example computer system 1400 that may include and/or be used to perform any of the operations described herein. For instance, computer system 1400 can implement architecture 100 of FIG. 1; also, computer system 1400 can host service 105. Computer system 1400 may take various different forms. For example, computer system 1400 may be embodied as a tablet, a desktop, a laptop, a mobile device, or a standalone device, such as those described throughout this disclosure. Computer system 1400 may also be a distributed system that includes one or more connected computing components/devices that are in communication with computer system 1400.

In its most basic configuration, computer system 1400 includes various different components. FIG. 14 shows that computer system 1400 includes a processor system 1405 that includes one or more hardware processor(s) (aka a “hardware processing unit”) and a storage system 1410 that includes one or more hardware storage devices.

Regarding the processor(s) of processors system 1405, it will be appreciated that the functionality described herein can be performed, at least in part, by one or more hardware logic components. For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1400. The different components, modules, engines, and services described herein may be implemented as objects or processors that execute on computer system 1400 (e.g. as separate threads).

Storage system 1410 may be physical system memory, which may be volatile, non-volatile, or some combination of the two. The term “memory” may also be used herein to refer to non-volatile mass storage such as physical storage media. If computer system 1400 is distributed, the processing, memory, and/or storage capability may be distributed as well.

Storage system 1410 is shown as including executable instructions 1415. The executable instructions 1415 represent instructions that are executable by the processor(s) of the processor system 1405 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1400 may also be connected (via a wired or wireless connection) to external sensors (e.g., one or more remote cameras) or devices via a network 1420. For example, computer system 1400 can communicate with any number devices or cloud services to obtain or process data. In some cases, network 1420 may itself be a cloud network. Furthermore, computer system 1400 may also be connected through one or more wired or wireless networks to remote/separate computer systems(s) that are configured to perform any of the processing described with regard to computer system 1400.

A “network,” like network 1420, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1400 will include one or more communication channels that are used to communicate with the network 1420. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more hardware storage devices that store instructions that are executable by the one or more processors to cause the computer system to:
access an image of a scene, wherein the image includes pixels representing an object included in the scene;
generate, via a machine learning engine, a first classification for the pixels representing the object, wherein first metadata for the object is structured to include the first classification;
generate, via the machine learning engine, a second classification for the scene, as represented in the image, wherein second metadata for the image is structured to include the second classification;
receive user input directed to the image, the user input comprising at least one of:
a cursor hovering over one or more of the pixels representing the object in the scene, a selection of the one or more pixels representing the object, or a movement of the cursor over the one or more pixels representing the object; and
in response to the user input, trigger playback of an audio output comprising audio details describing the first classification for the object.

2. The computer system of claim 1, wherein the user input is the cursor hovering over the one or more of the pixels representing the object in the scene.

3. The computer system of claim 1, wherein the user input is the selection of the one or more pixels representing the object.

4. The computer system of claim 1, wherein the user input is the movement of the cursor over the one or more pixels representing the object.

5. The computer system of claim 1, wherein the audio output is generated by a large language model (LLM).

6. The computer system of claim 1, wherein the first classification includes a determined type for the object.

7. The computer system of claim 1, wherein the first metadata for the object further includes location data for the object.

8. The computer system of claim 7, wherein the location data include image pixel coordinates for the pixels relative to the image.

9. The computer system of claim 7, wherein the location data includes proximity information of the object represented by the image relative to another object that is also represented in the image.

10. The computer system of claim 1, wherein the second metadata for the image includes descriptions of multiple different groups of objects, where one group includes said object.

11. A method comprising:
accessing an image of a scene, wherein the image includes pixels representing an object included in the scene;
generating a first classification for the pixels representing the object, wherein first metadata for the object is structured to include the first classification;
generating a second classification for the scene, as represented in the image, wherein second metadata for the image is structured to include the second classification;
receiving user input directed to the image, the user input comprising at least one of: a cursor hovering over one or more of the pixels representing the object in the scene, a selection of the one or more pixels representing the object, or a movement of the cursor over the one or more pixels representing the object; and
in response to the user input, triggering playback of an audio output comprising audio details describing the first classification for the object.

12. The method of claim 11, wherein the audio details further include location information for the object.

13. The method of claim 12, wherein the location information includes a proximity of the object relative to a second object that is also represented in the image and that is included in the scene.

14. The method of claim 11, wherein the object is a product, and wherein the first classification includes product details for the product, at least some of the product details being identified from recognizable package details for the object, as identified from within the image.

15. The method of claim 11, wherein generating the first classification is performed via object segmentation of the image.

16. One or more hardware storage devices that store instructions that are executable by one or more processors to cause the one or more processors to:
access an image of a scene, wherein the image includes pixels representing an object included in the scene;
generate a first classification for the pixels representing the object, wherein first metadata for the object is structured to include the first classification;
generate a second classification for the scene, as represented in the image, wherein second metadata for the image is structured to include the second classification;
receive user input directed to the image, the user input comprising at least one of: a cursor hovering over one or more of the pixels representing the object in the scene, a selection of the one or more pixels representing the object, or a movement of the cursor over the one or more pixels representing the object; and
in response to the user input, trigger playback of an audio output comprising audio details describing the first classification for the object.

17. The one or more hardware storage devices of claim 16, wherein the second classification for the scene includes a description of multiple different objects that are included in the image and that are included in the scene, the multiple different objects including said object, and wherein the second classification includes the second classification including relative proximity information for the multiple different objects.

18. The one or more hardware storage devices of claim 16, wherein the image includes second pixels representing a second object in the scene, and wherein the instructions are further executable to cause the one or more processors to:
generate a third classification for the second pixels representing the second object in the scene, wherein third metadata for the second object is structured to include the third classification;
wherein the audio details further include location information describing a proximity of the object relative to the second object in the scene.

19. The one or more hardware storage devices of claim 18, wherein the instructions are further executable to cause the one or more processors to:
receive second user input, the second user input comprising the cursor hovering over one or more of the second pixels representing the second object; and
in response to the second user input, triggering playback of a second audio output comprising second audio details describing the second object, wherein the second audio details includes information describing the proximity of the object relative to the second object in the scene.

20. The one or more hardware storage devices of claim 16, wherein a large language model (LLM) generates the first classification, the second classification, and the audio output.
